(19) United States
(12) Patent Application Publication
(10) Pub. No.: US 2016/0319400 A1
(43) Pub. Date: Nov. 3, 2016

(54) Aluminum Casting Alloy with Improved High-Temperature Performance

(71) Applicant: RIO TINTO ALCAN INTERNATIONAL LIMITED, Montréal (CA)

(72) Inventors: Bradly L. Hohenstein, Sidney, OH (US); James Frederick Major, Kingston (CA)

(21) Appl. No.: 15/104,111

(22) PCT Filed: Dec. 12, 2014
(86) PCT No.: PCT/CA2014/051206

§ 371 Date: Jun. 13, 2016

Related U.S. Application Data
(60) Provisional application No. 61/915,916, filed on Dec. 13, 2013.

(51) Int. Cl. C22C 21/16; C22F 1/057; F01D 5/28; B22D 25/02; B22D 27/11; C22C 21/14; B22D 21/00

(52) U.S. Cl. CPC C22C 21/16; C22C 21/14; C22F 1/057; B22D 21/007; B22D 25/02; B22D 27/11; F01D 5/28; F05D 2230/21; F05D 2220/40; F05D 2300/173; F05D 2240/30; F05D 2300/609; F05D 2300/701

(57) ABSTRACT

An aluminum alloy includes, in weight percent, 0.1-0.25 Si, 0.10 max Fe, 2.0-3.4 Cu, 0.9-1.2 Ni, 1.3-1.8 Mg, 0.25 max Ti, and one or more dispersoid forming elements, the balance being aluminum and unavoidable impurities. The alloy is suitable for casting, and may be formed into a cast alloy product. Additionally, the alloy exhibits excellent high temperature mechanical properties, particularly high temperature fatigue strength, as well as good corrosion resistance.

### CROSS-REFERENCE TO RELATED APPLICATION

This application is a non-provisional of and claims priority to U.S. Provisional Application No. 61/915,916, filed Dec. 13, 2013, which application is incorporated by reference herein in its entirety and made part hereof.

### FIELD OF THE INVENTION

The present invention relates generally to an aluminum alloy for use in casting and other applications, and in some specific aspects, to an aluminum alloy with improved strength, fatigue resistance, and corrosion resistance at high temperatures, as well as methods for processing such alloys.

### BACKGROUND

Certain aluminum alloy parts for use in high-temperature applications (e.g., up to 200° C.), such as turbocharger impellers, are often made by forging 2XXX series aluminum alloys. For example, turbocharger impellers are often made from forged 2618-T6 alloy. Such parts may also be made by casting 3XX series alloys, such as 354.0-T6. However, such existing alloys have certain drawbacks and limitations. For example, existing forged alloys may suffer from corrosion problems, particularly at higher operating temperatures. Further, forged alloys have the additional disadvantages of being inherently more costly to produce than cast alloys (potentially up to 3-4X), as well as having limited design flexibility, due to the nature of the forging and machining required for production. Existing casting alloys such as C355.0-T61 and 354.0-T6 have mechanical properties that degrade at higher operating temperatures (e.g., above 150° C.), such as strength and fatigue resistance. Some existing cast aluminum alloys have utilized high levels of copper or iron to produce increased tensile and yield strength. However, increased Cu content is detrimental to the corrosion resistance of such alloys, and increased Fe content is extremely detrimental to high temperature fatigue strength.

Thus, such alloys have limitations when used at high temperatures, and such limitations may impact the performance limitations of the turbocharger itself. The present invention is provided to address at least some of these problems and other problems, and to provide advantages and aspects not provided by prior alloys, processing methods, and articles. A full discussion of the features and advantages of the present invention is deferred to the following detailed description.

### BRIEF SUMMARY

The following presents a general summary of aspects of the invention in order to provide a basic understanding of the invention. This summary is not an extensive overview of the invention. It is not intended to identify key or critical elements of the invention or to delineate the scope of the invention. The following summary merely presents some concepts of the invention in a general form as a prelude to the more detailed description provided below.

Aspects of the disclosure relate to an aluminum casting alloy with a composition, in weight percent, including:

Si: 0.1-0.25

Fe: 0.10 max

Cu: 2.0-3.4

Ni: 0.9-1.2

Mg: 1.3-1.8

Ti: 0.25 max, and

one or more dispersoid forming elements, the balance being aluminum and unavoidable impurities. In one embodiment, the unavoidable impurities may each be present at a maximum content of 0.05 wt. %, and the maximum total content of the unavoidable impurities may be 0.15 wt. %.

1⁷1 According to one aspect, the one or more dispersoid forming elements are selected from the group consisting of: vanadium, zirconium, manganese, chromium, scandium, hafnium, niobium, yttrium, titanium, and combinations thereof. Each dispersoid forming element may be present in an amount of up to 0.20 wt. %, or up to 0.15 wt. %, in various embodiments. Alternately, the dispersoid forming element(s) may collectively be present in an amount of up to 0.20 wt. %, or up to 0.15 wt. %, in various embodiments.

According to another aspect, the alloy may have an iron content of 0.08 max wt. % or 0.06 max wt. %.

According to a further aspect, the alloy may have a copper content of 2.0-3.2 wt. % or 2.0-3.0 wt. %.

According to additional aspects, the alloy may have a titanium content of 0.20 max wt. %, and/or the alloy may have a zinc content of 0.1 max wt. % as an impurity.

According to yet another aspect, the alloy is cast, and the cast alloy may have an average grain size of the alloy of 100 μm or less. The average grain size in the cast alloy may be 50 μm or less in one embodiment.

Additional aspects of the disclosure relate to an aluminum alloy product, such as a cast aluminum alloy product, formed of an aluminum alloy as described herein. One example of such a cast aluminum alloy product is a turbocharger impeller or compressor wheel. Many other different types of cast aluminum alloy products or other aluminum alloy products may be manufactured using the alloy. The cast product may be solution heat treated and/or artificially aged after casting, such as by a T7 heat treatment.

According to one aspect, the cast product can withstand at least 150,000 cycles at a load of 250 MPa after soaking at least 1000 hours at a temperature of 200° C. In other embodiments, the cast product can withstand at least 200,000 or 250,000 cycles under these same conditions.

According to another aspect, the cast product has a B1 reliability value of at least 60,000 cycles at a load of 250 MPa after soaking at least 1000 hours at a temperature of 200° C.

According to a further aspect, the cast product has a B1 reliability value of at least 90,000 cycles at a load of 250 MPa after soaking at least 1000 hours at a temperature of 175° C.

According to yet another aspect, the cast product has a B10 reliability value of at least 100,000 cycles at a load of 250 MPa after soaking at least 1000 hours at a temperature of 175° C. or 200° C.

Further aspects of the disclosure relate to a method of forming a cast product, which includes casting an aluminum alloy as described herein to form the cast product, subjecting the cast product to hot isostatic pressing, solution heat treating the cast product, and artificially aging the cast product. The heat treatment and aging process may utilize a T7 heat treatment process in one embodiment.

Other features and advantages of the invention will be apparent from the following description taken in conjunction with the attached drawings.

### BRIEF DESCRIPTION OF THE DRAWINGS

To allow for a more full understanding of the present invention, it will now be described by way of example, with reference to the accompanying drawings in which:

FIG. 1 is a perspective view of a cast article in the form of a turbocharger impeller, which may be manufactured using an alloy according to aspects of the present disclosure;

FIG. 2 is a comparison of ultimate tensile strength between different alloys after 30 minute soak at various temperatures, as described in Example 1 below;

FIG. 3 is a comparison of ultimate tensile strength between different alloys after 1000 hour soak at various temperatures, as described in Example 1 below;

FIG. 4 is a comparison of yield strength between different alloys after 30 minute soak at various temperatures, as described in Example 1 below;

FIG. 5 is a comparison of yield strength between different alloys after 1000 hour soak at various temperatures, as described in Example 1 below;

FIG. 6 is a comparison of elongation between different alloys after 30 minute soak at various temperatures, as described in Example 1 below;

FIG. 7 is a comparison of elongation between different alloys after 1000 hour soak at various temperatures, as described in Example 1 below;

FIG. 8 is a comparison of fatigue strength between different alloys after 30 minute soak at various temperatures, as described in Example 1 below;

FIG. 9 is a comparison of fatigue strength between different alloys after 1000 hour soak at various temperatures, as described in Example 1 below;

FIG. 10 is a photograph of a sample used in corrosion testing as described in Example 2 below;

FIG. 11 includes photomicrographs illustrating corrosion at the surface of cast samples of Alloy A-T7 as described in Example 2 below;

FIG. 12 includes photomicrographs illustrating corrosion at the surface of forged samples of 2618-T6 alloy as described in Example 2 below;

FIG. 13 includes photomicrographs illustrating corrosion at the surface of cast samples of 354.0-T6 alloy as described in Example 2 below;

FIG. 14 includes photomicrographs illustrating grain sizes of different alloys as described in Example 3 below;

FIG. 15 is a comparison of ultimate tensile strength, tensile yield strength, and tensile elongation between samples of Alloy A having different grain sizes, after 30 minute soak at various temperatures, as described in Example 3 below;

FIG. 16 is a comparison of fatigue strength between samples of Alloy A having different grain sizes after 30 minute soak at various temperatures, as described in Example 3 below;

FIG. 17 is a comparison of ultimate tensile strength of alloy samples having different iron levels after 1000 hour soak at various temperatures, as described in Example 4 below,

FIG. 18 is a comparison of yield strength of alloy samples having different iron levels after 1000 hour soak at various temperatures, as described in Example 4 below;

FIG. 19 is a comparison of elongation of alloy samples having different iron levels after 1000 hour soak at various temperatures, as described in Example 4 below;

FIG. 20 is a comparison of fatigue strength of alloy samples having different iron levels after 1000 hour soak at various temperatures, as described in Example 4 below; and

FIGS. 21A-D are scanning electron micrographs of alloy samples having different iron levels, as described in Example 4 below.

### DETAILED DESCRIPTION

In general, the alloy composition described herein provides an aluminum alloy that is suitable for casting complex shapes, with reduced copper content and iron content to produce improved high temperature corrosion resistance and fatigue strength, respectively. The cast alloy surprisingly produces similar or even superior mechanical properties at high temperatures (e.g., up to 200° C.) as compared to comparable forged alloys for the same end uses, with lower cost required for production.

Aspects of the disclosure relate to an aluminum alloy composition suitable for casting, comprising, in weight percent:

Si 0.1-0.25;

Fe 0.10 max;

Cu 2.0-3.4;

Mg 1.3-1.8;

Ni 0.9-1.2;

Ti 0.25 max; and

one or more dispersoid forming elements, the balance being aluminum and unavoidable impurities.

The alloy may include silicon in an amount of 0.1-0.25 wt. % in one embodiment. In other embodiments, the alloy may include 0.15-0.25 wt. % or 0.20-0.25 wt. % silicon. Additionally, the alloy may include magnesium in an amount of 1.3-1.8 wt. % in one embodiment. The silicon and magnesium additions can increase the strength of the alloy.

The alloy may include iron in an amount of 0.10 max wt. % in one embodiment, or 0.08 max wt. % in another embodiment, or 0.06 max wt. % in a further embodiment. As stated below, this reduced iron content improves the high temperature fatigue resistance of the alloy.

The alloy may include copper in an amount of 2.0-3.4 wt. % in one embodiment, or 2.0-3.2 wt. % in another embodiment, or 2.0-3.0 wt. % in a further embodiment. Copper additions can increase the strength of the alloy. However, as described above, these copper additions are limited so as not to reduce the corrosion resistance of the alloy.

The alloy may include nickel in an amount of 0.9-1.2 wt. % in one embodiment. Nickel additions can increase the strength of the alloy.

The alloy may include titanium in an amount of 0.25 max wt. % in one embodiment, or 0.20 max wt. % in another embodiment. In further embodiments, the alloy may include titanium in amounts of 0.04-0.25 wt. %, 0.10-0.25 wt. %, 0.04-0.20 wt. %, or 0.10-0.20 wt. %. Titanium generally functions as a grain refiner in the alloy, and assists in achieving a fine grain size. At least some Ti may be added in the form of TiB₂ and/or in the form of a commercial Ti—B grain refiner alloy (e.g., 5:1 Ti—B) for this purpose, in one embodiment. As described below, Ti may also function as a dispersoid forming element, adding high temperature creep resistance to the alloy.

The alloy may further include one or more dispersoid forming elements, in one embodiment. Dispersoid forming elements may include, without limitation, vanadium, zirconium, manganese, chromium, scandium, hafnium, niobium, yttrium, titanium, and combinations thereof. Such dispersoid forming elements may be included in an amount of up to 0.20 wt. % or up to 0.15 wt. %, or in an amount from 0.05-0.20 wt. % or 0.05-0.15 wt. %, either individually or collectively, in various embodiments. In one embodiment, the alloy may include vanadium and/or zirconium in an amount of up to 0.20 wt. % or up to 0.15 wt. %, or in an amount from 0.05-0.20 wt. % or 0.05-0.15 wt. %. Dispersoids formed by the inclusion of such elements can assist in resisting creep, particularly at elevated temperatures, and may increase strength as well.

The balance of the alloy includes aluminum and unavoidable impurities. The unavoidable impurities may each be present at a maximum weight percent of 0.05, and the maximum total weight percent of the unavoidable impurities may be 0.15, in one embodiment. Additionally, the alloy may include zinc as an impurity in an amount of 0.1 max wt. % in one embodiment. The alloy may include further alloying additions in another embodiment.

The alloy may be used in forming a variety of different articles, and may be initially produced as a precursor product, such as ingots, as well as billets and other intermediate products that may be produced via a variety of techniques, including casting techniques such as continuous or semi-continuous casting and others. Further processing may be used to produce articles of manufacture using the alloy, such as cast articles, which may be produced by melting and casting the ingot or other precursor product to form the cast article. It is understood that a cast article may have a complex geometry in one embodiment, including one or more internal cavities or concave portions and/or a non-constant cross-sectional shape, and may be further processed to change the shape or form of the article, such as by cutting, machining, connecting other components, or other techniques.

The alloy may have a fine grain size, which can increase the fatigue resistance of the alloy, particularly at high temperatures. For example, the alloy may have a grain size of about 50 μm or less, or about 100 μm or less, in various embodiments. As described above, titanium (e.g. TiB₂) additions can be used to control grain size. Metallographic evaluation techniques or the use of a thermal analyzer can be used to monitor grain size in production settings.

Generally, the alloy has excellent mechanical properties, particularly at high temperatures, such as up to 200° C. or even greater than 200° C. In one embodiment, the cast alloy may be able to withstand at least 150,000 cycles at a stress of 250 MPa after soaking at least 1000 hours at 175° C. or 200° C. In other embodiments, the cast alloy may be able to withstand at least 200,000 cycles, or at least 250,000 cycles under the same conditions. A bending fatigue test on a disk, with cycles at a stress of 250 MPa, non-reversed with R=0.1, may be used to determine the fatigue properties of the alloy as described above. The fatigue resistance of the alloy may also be expressed using B1 or B10 values determined by using Weibull Reliability Analysis techniques, which are well-known techniques in the field of reliability engineering to predict the probable distribution associated with the lifetime of a particular part, focused on failure rate. The B1 value indicates a time when the population's predicted reliability is 99%, i.e., that 1% would fail prior to that time. The B10 value indicates a time when the population's predicted reliability is 90%, i.e., that 10% would fail prior to that time. Using this analysis technique, a part produced from an alloy as described herein may have a B1 reliability value after 1000 hours of exposure at 175° C. of at least 90,000 cycles, or at least 110,000 cycles, or at least 130,000 cycles, and may have a B1 reliability value after 1000 hours of exposure at 200° C. of at least 60,000 cycles, or at least 80,000 cycles, or at least 100,000 cycles, under a load of 250 MPa, in certain embodiments. Additionally, a part produced from an alloy as described herein may have a B10 reliability value after 1000 hours of exposure at 175° C. or at 200° C. of at least 100,000 cycles, or at least 125,000 cycles, or at least 150,000 cycles, under a load of 250 MPa, in certain embodiments. It is understood that the alloy may exhibit increased fatigue strength using other testing procedures as well, including industry standard procedures. It is also understood that these fatigue properties may be indicative of performance of the alloy after casting, solution treatment and aging heat treatment (e.g., a T7 heat treatment).

Additionally, the alloy may have a tensile strength of at least 300 MPa and/or a yield strength of at least 275 MPa after soaking at least 1000 hours at 175° C., and may have a tensile strength of at least 240 MPa and/or a yield strength of at least 210 MPa after soaking at least 1000 hours at 200° C., in various embodiments. Further, the alloy may have a tensile strength of at least 375 MPa or at least 400 MPa and/or a yield strength of at least 325 MPa or at least 340 MPa at room temperature, in various embodiments. ASTM B557, ASTM E8/8M, and/or ASTM E21, or other common testing standards, may be used to determine the tensile properties of the alloy. It is understood that these tensile properties may be indicative of performance of the alloy after casting, solution treatment and aging heat treatment (e.g., a T7 heat treatment).

The alloy may be processed using one or more of a variety of techniques, such as to form an article and/or achieve desired properties. As described above, such processing may include casting the alloy or forming the alloy into an article using a different technique. Examples of potential casting techniques that may be used in forming the alloy include, without limitation, vacuum assisted counter-pressure casting, high pressure die casting or other die casting, gravity casting, squeeze casting, sand casting, semi-permanent mold casting, and others. Such processing may also include hot isostatic pressing (HIP) after casting, to reduce or eliminate porosity in the cast alloy. One HIP process that may be used is conducted at a pressure of 103,390 MPa, with the article being heated to about 475° C. for about 10 minutes and then heated to about 495° C. for about 2 hours. Such processing may also include a solution treatment and/or an aging heat treatment, such as a T7 heat treatment. One solution heat treatment that may be used is heating the article to about 490° C. for about 3 hours and then heating to about 525° C. for about 17 hours, then quenching in water at 60° C. to 80° C., leaving in the water for 30 minutes, then air drying. One artificial aging treatment that may be used (following the solution heat treatment) is heating the article to 200° C. for 20 hours. Other processing techniques may be used in further embodiments, including other post-casting processing techniques. For example, the raw castings may be finish machined after heat treatment. The alloy may be processed and formed using other techniques as well, for example by use of a forging technique.

The alloy may include at least some Fe-containing intermetallics (e.g., FeSiAl or Fe—Ni intermetallics) that form during casting and/or processing. These intermetallics may be detrimental to the high-temperature fatigue properties of the alloy. In one embodiment, the alloy includes only limited amounts of such Fe-containing intermetallics, after casting, solution treatment and aging heat treatment (e.g., a T7 heat treatment).

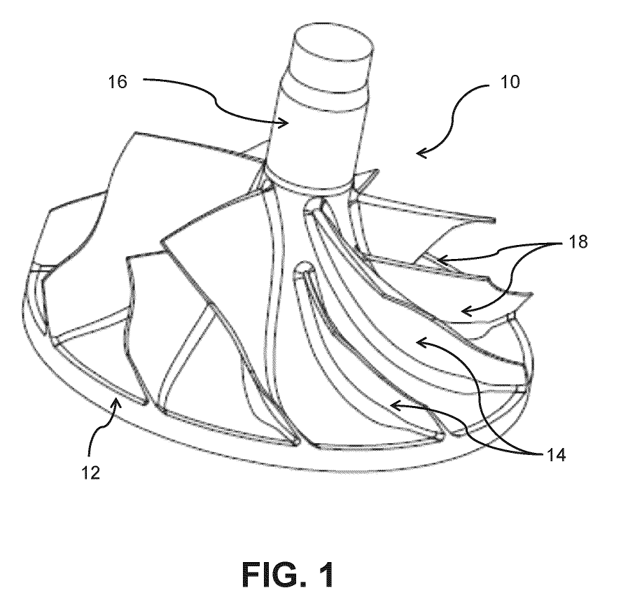

The casting methods described above may provide an aluminum alloy casting or a cast aluminum alloy product formed of an alloy as described above. One example of such a product is a turbocharger impeller or compressor wheel 10, as illustrated in FIG. 1, which may include a circular plate 12 with a plurality of blades or fins 14 connected to the plate 12 and radiating outward from a central rotation shaft 16. As described above, this impeller 10 includes internal cavities or concave portions 18 between the blades 14 and has a non-constant cross-sectional shape over at least a portion of a length of any possible axis. The alloy may be useful for other applications, including other articles that are subjected to cyclic loads at high temperatures and/or potentially corrosive environmental conditions. In many such applications, the alloy may be used to form cast parts for applications where parts made by a different technique, such as forging, rolling, extrusion, machining, etc., are typically used. These cast parts made from the alloy can meet high-temperature fatigue requirements and other physical properties for such applications, for example, fatigue life requirements at temperatures of 175° C. or 200° C. or greater, under loads of up to 250 MPa.

The following examples illustrate beneficial properties that can be obtained with embodiments of the invention, including high temperature mechanical performance and corrosion resistance.

### EXAMPLE 1

[58] Mechanical property comparison testing was performed by comparing embodiments of Alloy A-T7 as described herein with standard 2618-T6 extruded and forged blanks and 354.0-T6 cast alloy. The chemistry of Alloy A embodiments for this Example are given in Table 1 below, along with the 354.0 cast and 2618 forged chemistries.

TABLE 1
Alloy Chemistries of Tested Materials (wt. %)

| Element: | Si | Fe | Cu | Mg | Ni | Ti | Mn | V | Zr |
|---|---|---|---|---|---|---|---|---|---|
| A1 | 0.20 | 0.06 | 2.18 | 1.31 | 1.04 | 0.14 | 0.00 | 0.00 | 0.12 |
| A2 | 0.23 | 0.05 | 2.21 | 1.64 | 1.05 | 0.17 | 0.10 | 0.13 | 0.10 |
| A3 | 0.23 | 0.04 | 2.34 | 1.63 | 1.01 | 0.17 | 0.01 | 0.12 | 0.10 |
| A4 | 0.25 | 0.04 | 2.39 | 1.54 | 1.00 | 0.18 | 0.00 | 0.11 | 0.12 |
| A5 | 0.24 | 0.04 | 2.84 | 1.50 | 1.03 | 0.18 | 0.00 | 0.11 | 0.15 |
| A6 | 0.25 | as noted | 2.15 | 1.35 | 1.00 | 0.20 | 0.01 | 0.13 | 0.14 |
| Alloy B | 0.23 | 0.08 | 2.44 | 1.43 | 1.11 | 0.11 | 0.01 | 0.11 | 0.13 |
| 354.0 | 8.76 | 0.08 | 1.63 | 0.52 | 0 | 0.20 | 0.00 | 0 | 0 |
| 2618 | 0.23 | 1.03 | 2.22 | 1.58 | 1.01 | 0.06 | 0.03 | 0 | 0 |

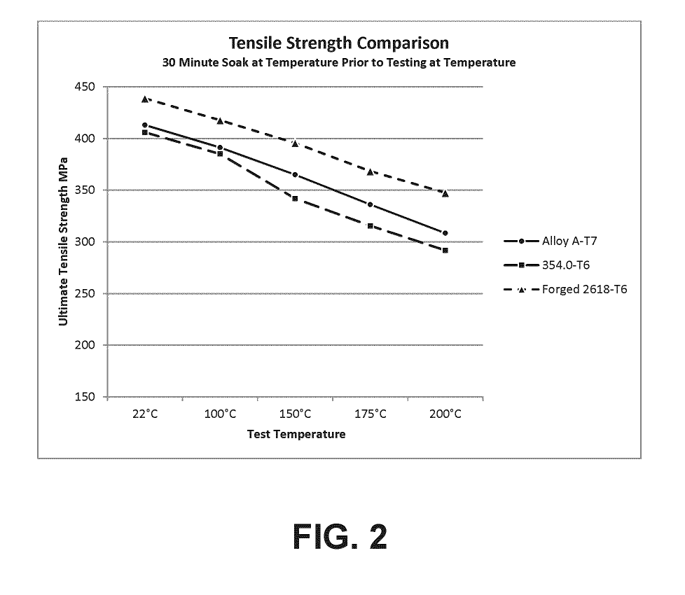

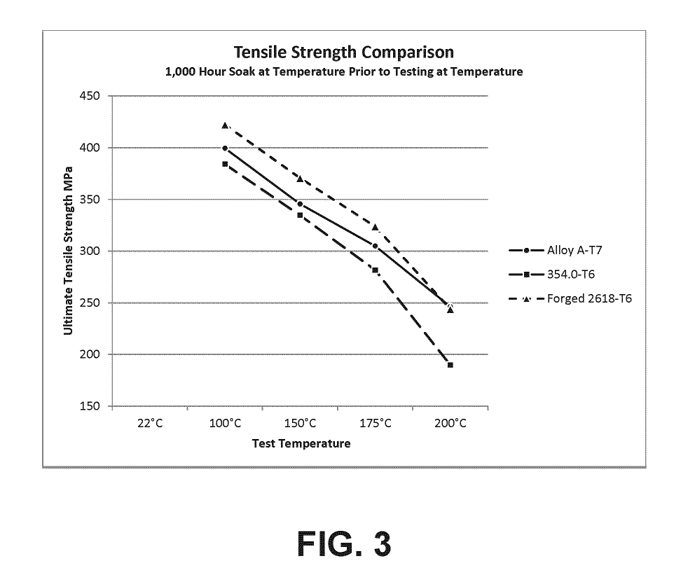

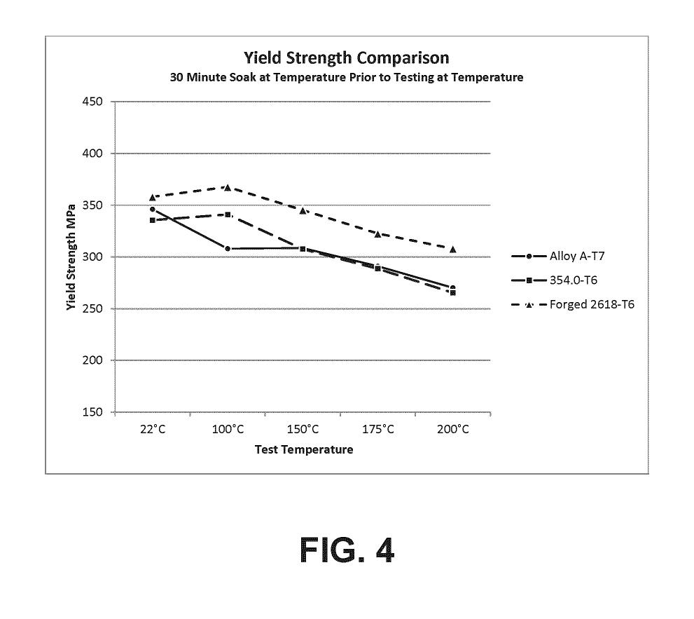

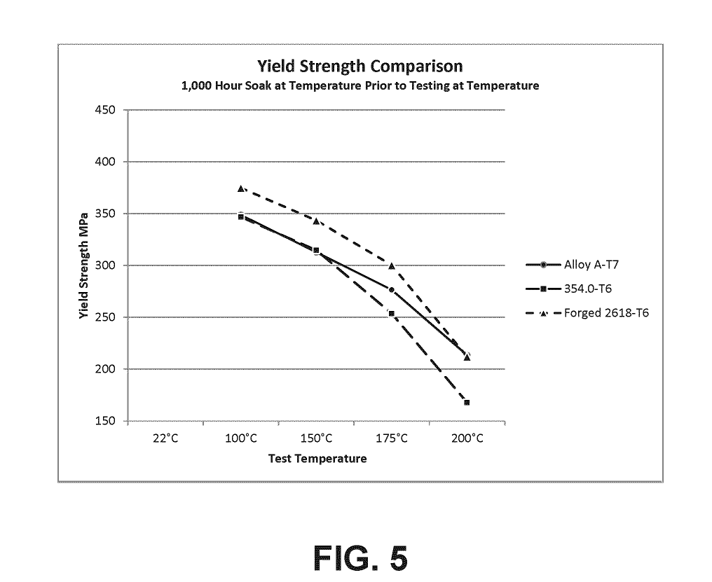

Samples of Alloy A embodiments A1, A2, A3, A4, and A5 were produced by machining from cast compressor wheels after the cast wheels were subjected to HIP and a T7 heat treatment as described above. The samples of 354.0 alloy were produced by machining from cast compressor wheels after the cast wheels were subjected to HIP and a T6 heat treatment. The samples of the 2618 alloy were produced by machining from forged 2618 compressor wheel blanks that were heat treated to a T6 heat treatment. The tensile samples were in conformance with ASTM B557 and the fatigue testing samples were disk-shaped. The samples were then heated to various temperatures, including room temperature (22° C.), 100° C., 150° C., 175° C., and 200° C. and soaked for 30 minutes and 1000 hours. After the soaking was complete, testing of tensile strength, yield strength, and elongation of each alloy was conducted in conformance with ASTM E21 and B557 at the soaking temperatures. Fatigue testing was also conducted according to a bending fatigue test as described above, using a stress of 250 MPa, at each of the above temperatures. Results of this testing are illustrated in FIGS. 2-9, as well as Tables 2-4 below. In these results and in the analysis below, the term “Alloy A” is used to refer to an average of the results from all the Alloy A embodiments tested, i.e., A1, A2, A3, A4, and A5.

TABLE 2
Ultimate Tensile Strength (MPa)

| Tensile Strength | | 30 Minute Soak | | Tensile Strength | | 1000 Hour Soak | |
|---|---|---|---|---|---|---|---|
| | Alloy A-T7 | 354.0-T6 | 2618-T6 | | Alloy A-T7 | 354.0-T6 | 2618-T6 |
| 22° C. | 413 | 406 | 439 | 22° C. | | | |
| 100° C. | 391 | 385 | 418 | 100° C. | 399 | 384 | 422 |
| 150° C. | 365 | 342 | 396 | 150° C. | 346 | 335 | 371 |
| 175° C. | 336 | 316 | 368 | 175° C. | 305 | 282 | 324 |
| 200° C. | 308 | 292 | 347 | 200° C. | 246 | 190 | 244 |

TABLE 3
Yield Strength (MPa)

| Yield Strength | | 30 Minute Soak | | Yield Strength | | 1000 Hour Soak | |
|---|---|---|---|---|---|---|---|
| | Alloy A-T7 | 354.0-T6 | 2618-T6 | | Alloy A-T7 | 354.0-T6 | 2618-T6 |
| 22° C. | 346 | 336 | 358 | 22° C. | | | |
| 100° C. | 308 | 341 | 368 | 100° C. | 349 | 347 | 375 |
| 150° C. | 309 | 308 | 345 | 150° C. | 313 | 315 | 343 |
| 175° C. | 291 | 289 | 323 | 175° C. | 276 | 254 | 300 |
| 200° C. | 270 | 265 | 308 | 200° C. | 214 | 168 | 212 |

TABLE 4
Tensile Elongation

| % Elongation | | 30 Minute Soak | | % Elongation | | 1000 Hour Soak | |
|---|---|---|---|---|---|---|---|
| | Alloy A-T7 | 354.0-T6 | 2618-T6 | | Alloy A-T7 | 354.0-T6 | 2618-T6 |
| 22° C. | 6.8 | 6.6 | 9.5 | | | | |
| 100° C. | 6.6 | 7.9 | 9.9 | 100° C. | 7.2 | 8.6 | 9.5 |
| 150° C. | 10.7 | 10.4 | 14.8 | 150° C. | 11.7 | 8.7 | 11.4 |
| 175° C. | 12.4 | 10.7 | 14.7 | 175° C. | 12.6 | 9.8 | 14.5 |
| 200° C. | 14.1 | 11.1 | 16.3 | 200° C. | 17.6 | 17.5 | 18.1 |

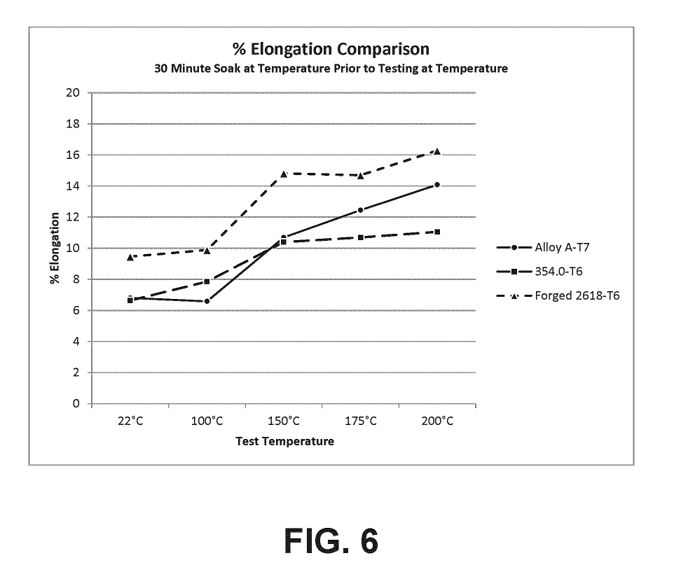

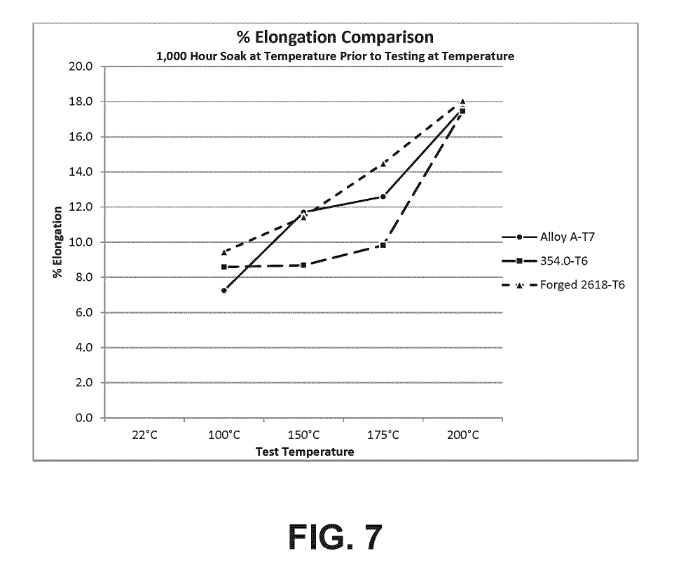

As seen in FIGS. 2-5 and Tables 2-3, the tensile and yield strengths of Alloy A were generally comparable to that of the 354.0 alloy and generally lower than the forged 2618 alloy at room temperature, and at all temperatures after 30-minute soaking. However, after 1000 hours soaking at temperatures of 175° C. and above, the tensile and yield strengths of Alloy A were more comparable to that of the 2618 alloy and were significantly higher than that of the 354.0 alloy. In fact, after 1000 hours soaking at 200° C., the tensile strength and the yield strength of Alloy A were similar or even greater than that of the forged 2618 alloy. This result is surprising, due to the lower room temperature strength of Alloy A, and due to the fact that forged alloys generally exceed the mechanical properties of cast alloys. Tensile elongation was suitable for Alloy A as well, as seen in Table 4 and FIGS. 6-7.

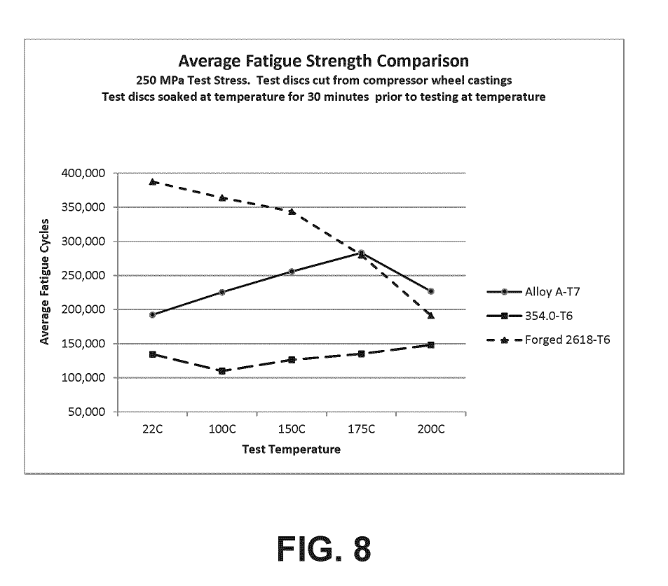

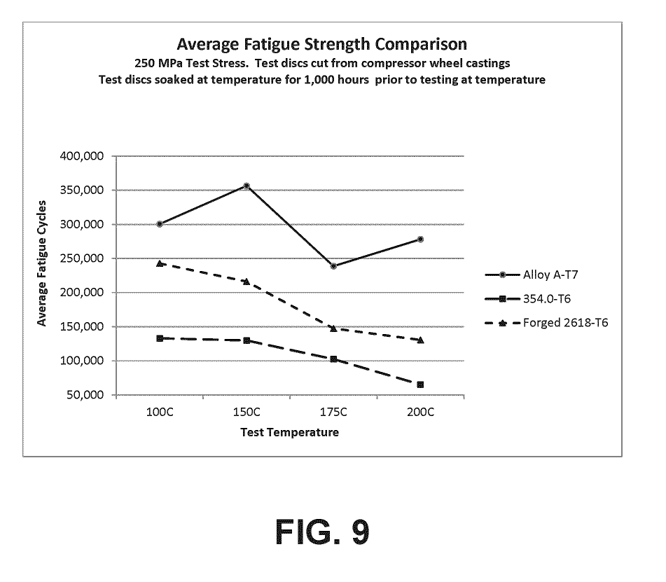

As seen in FIGS. 8-9, the fatigue performance of Alloy A was superior to that of the forged 2618 alloy after 30 minute soaking at temperatures of 175° C. and 200° C., and the fatigue performance of Alloy A was superior to that of the forged 2618 alloy after 1000 hour soaking at temperatures of 100° C. and above. In fact, for temperatures above 150° C., the fatigue performance of Alloy A was vastly superior to that of the forged 2618 alloy. These results were also surprising, due to the fact that the yield strength of Alloy A was similar to that of the forged 2618 alloy at those same temperatures, and because forged alloys typically exceed the mechanical properties of cast alloys. The fatigue performance of Alloy A was superior to that of the 354.0 cast alloy at all temperatures, often by a sizeable margin.

The fatigue data in the above tests was also used in Weibull Reliability Analysis to generate B1 and B10 values for the alloys tested. Tables 5 and 6 include this data at each testing temperature, after 1000 hours soaking at the stated temperatures.

TABLE 5
B1 Reliability (Weibull)

| Temperature | Fatigue Cycles (×10³) | | |
|---|---|---|---|
| (1000 hours) | Alloy A-T7 | 354.0-T6 | Forged 2618-T6 |
| 22° C. | 135 | 106.6 | 97.4 |
| 100° C. | 105.5 | 84.5 | 117.3 |
| 150° C. | 180.1 | 97.1 | 144.6 |
| 175° C. | 131.6 | 71.7 | 77.4 |
| 200° C. | 109.5 | 43.8 | 46.9 |

TABLE 6
B10 Reliability (Weibull)

| Temperature | Fatigue Cycles (×10³) | | |
|---|---|---|---|
| (1000 hours) | Alloy A-T7 | 354.0-T6 | Forged 2618-T6 |
| 22° C. | 141.4 | 114.7 | 99.1 |
| 100° C. | 144.2 | 90.4 | 118.7 |
| 150° C. | 195.8 | 98.6 | 152.9 |
| 175° C. | 152.9 | 77.4 | 82.6 |
| 200° C. | 179.8 | 46.9 | 78.1 |

The data in Tables 5 and 6 establish the significantly improved high-temperature fatigue resistance exhibited by Alloy A, as compared to the cast 354.0 alloy and the forged 2618 alloy.

In summary, this testing demonstrated Alloy A to have high temperature mechanical properties that were far superior to those of 354.0 cast alloy, and generally similar or even superior to the properties of 2618 forged alloy. In particular, the testing demonstrated Alloy A to have vastly superior fatigue resistance to both the 354.0 cast alloy and the 2618 forged alloy after prolonged exposures at temperatures greater than 150° C.

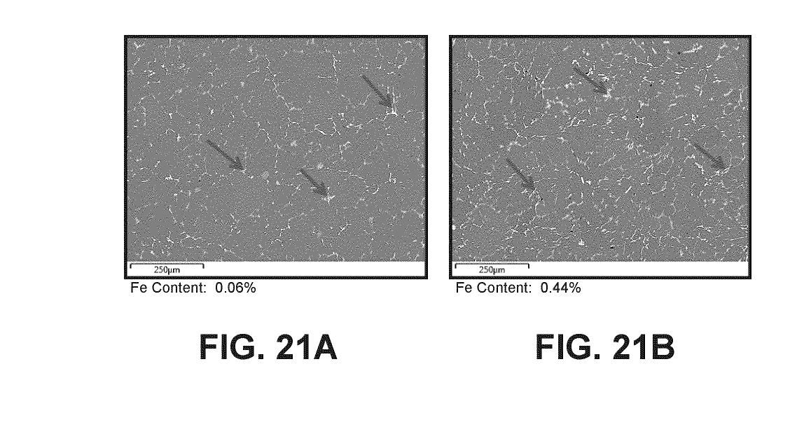

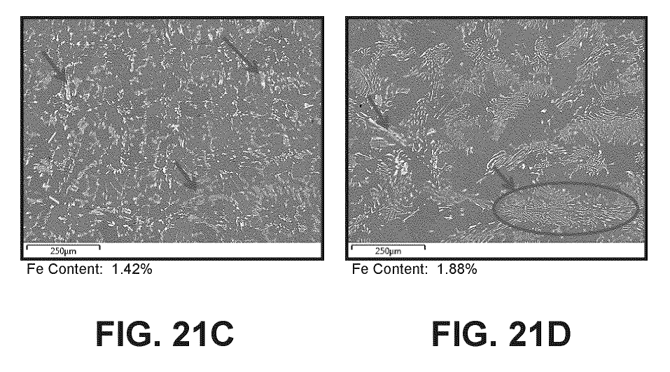

Without being bound by a particular theory, it is contemplated that a mechanism leading to increased fatigue resistance in Alloy A is the reduction of brittle Fe-containing intermetallics in the alloy (e.g., FeSiAl or Fe-Ni intermetallics, as illustrated in FIG. 21), due to decreased iron content. Forged 2618 alloy has a high-strength matrix that transfers little stress to Fe-containing intermetallics at room temperature, leading to good room-temperature performance. However at higher temperatures, softening of the matrix may transfer more stress to the brittle Fe-containing intermetallics, which can cause failure. By limiting or eliminating the amount of such Fe-containing intermetallics in Alloy A, such intermetallics do not cause failure at high temperatures, allowing for better fatigue performance. Additionally, the reduction or elimination of these Fe-containing intermetallics makes the alloy more suitable for casting applications. Intermetallics of this type can be broken up by mechanical working in forging alloys, however castings are generally not mechanically worked, and the formulation of Alloy A allows good mechanical properties to be achieved without working.

### EXAMPLE 2

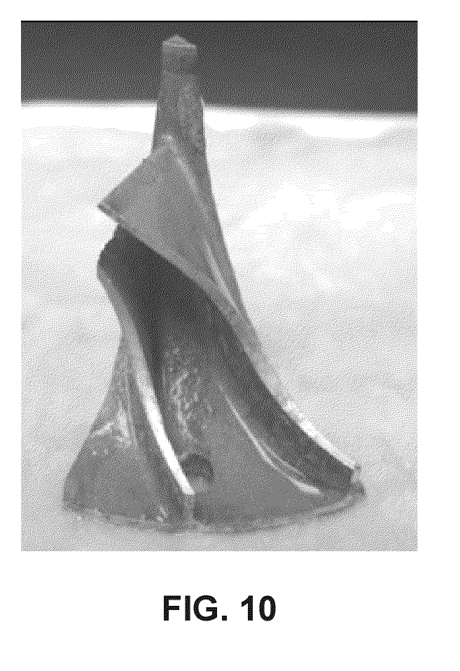

Corrosion comparison testing was performed by comparing samples of Alloy A (Alloys A1 and A2 from Table 1 above) with the forged 2618 alloy and 354.0 cast alloy, as described above in Example 1. Automotive compressor wheels were machined on a 5 axis CNC Mill from forged, pre-heat treated samples of the 2618 alloy and castings of the 354.0 alloy and Alloys A1 and A2. The compressor wheel castings were processed through hot isostatic pressing and heat treatment as described in Example 1 above, and then compared to the wheel produced from the heat treated, wrought 2618 material. The compressor wheels were sliced into sections (See FIG. 10) and hung in a salt fog chamber. The blade sections were tested in accordance with ASTM Standard B117 using a Q-Fog CTT1100 Cyclic Corrosion Tester. The samples from each alloy were initially placed into the corrosion chamber then removed individually at 12, 24, 48, 72, and 96 hours. The blade samples were then sectioned through the heaviest area of corrosion, mounted, and polished in accordance with ASTM Standard E3. The polished samples were then evaluated using an inverted metallograph. Depth of corrosion attack was recorded. The results are displayed in Table 7 below, and “Alloy A” is used here to refer to an average of Alloys A1 and A2.

TABLE 7
Depth of Corrosion Attack

| | Depth of | Depth of | Depth of |
|---|---|---|---|
| | Corrosion Attack | Corrosion Attack | Corrosion Attack |
| Hours of | (microns) | (microns) | (microns) |
| Exposure | Alloy A | Forged 2618 | 354.0 Alloy |
| 12 | 27.71 | 50.85 | 19.34 |
| 24 | 77.49 | 147.63 | 30.39 |
| 48 | 100.52 | 346.55 | 42.94 |
| 72 | 111.35 | 364.52 | 42.19 |
| 96 | 265.73 | 371.89 | 50.15 |

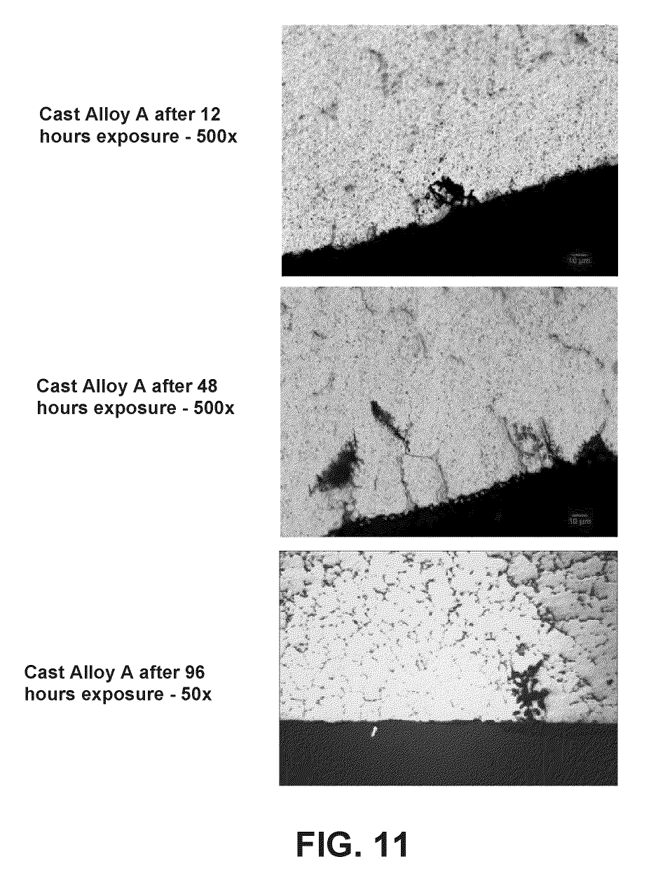

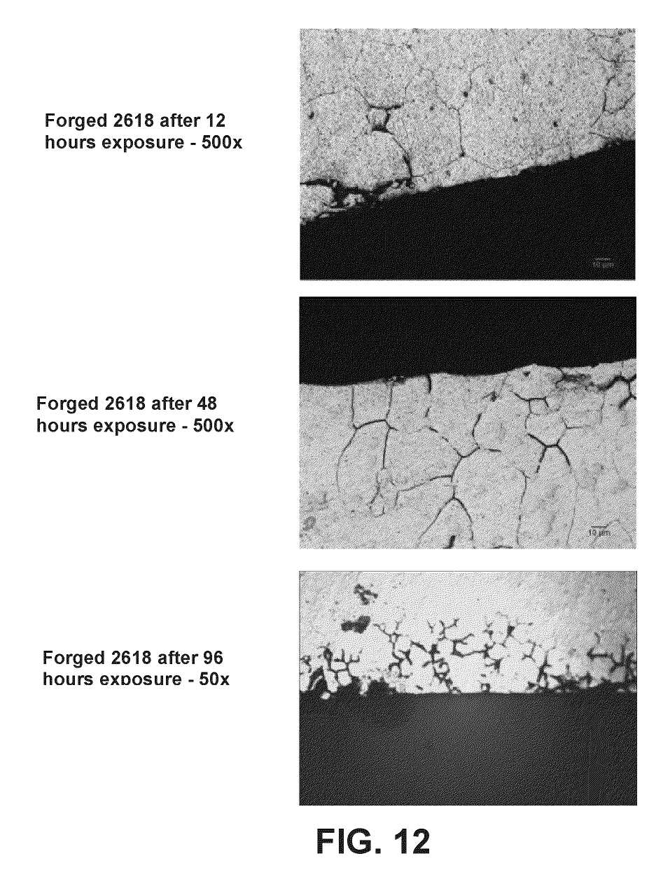

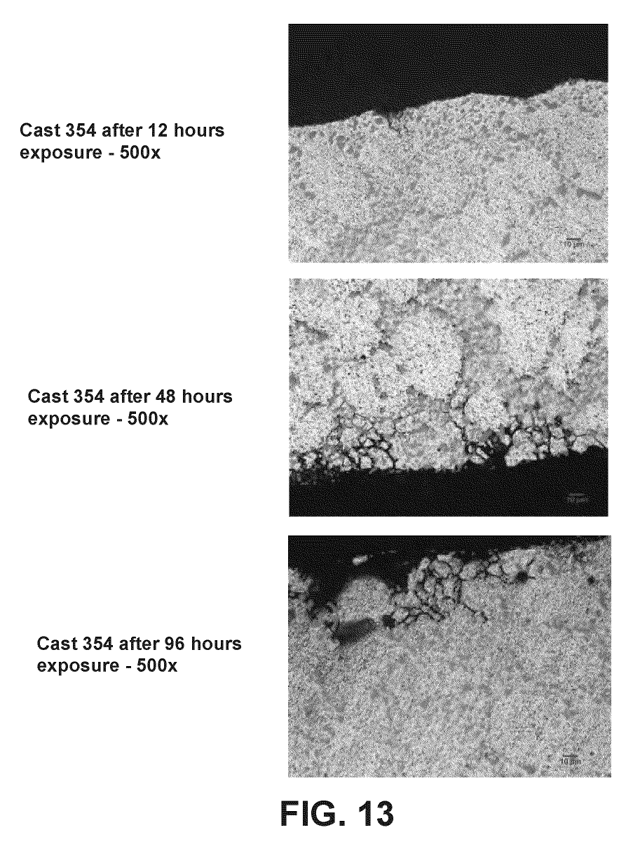

Example photos of the corrosion of the various samples at different exposure times are illustrated in FIGS. 11-13. The 354.0 material displayed some surface corrosion at each duration level, but no signs of intergranular corrosion, leading to lower corrosion depths. The surface corrosion became progressively worse as the time in the salt fog chamber increased. The area of attack was widespread across the surface of the part.

The 2618 forged material displayed major intergranular corrosion at each duration level. The intergranular corrosion became progressively worse as the duration period in the salt fog chamber increased. The area of attack was widespread across the surface of the part.

For the samples of Alloy A, small amounts of intergranular corrosion were detected, however the attack was much more localized than the corrosion attack of both the 354.0 cast alloy and the 2618 forged alloy, and Alloy A displayed a much lower depth of attack for the intergranular corrosion than the 2618 forged material.

In summary, salt fog corrosion testing demonstrated Alloy A to have much better corrosion resistance than the forged 2618 material. Without being bound by a particular theory, it is contemplated that the improved corrosion performance of Alloy A is due to the decreased iron and copper contents of Alloy A, as well as the use of the T7 heat treatment, in contrast to the T6 treatment of the 2618 alloy.

### EXAMPLE 3

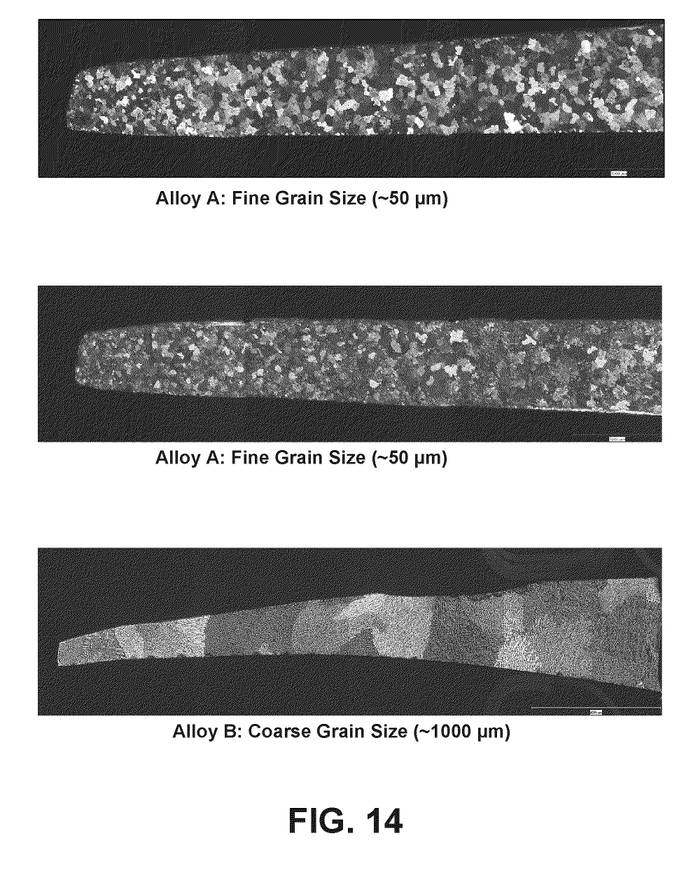

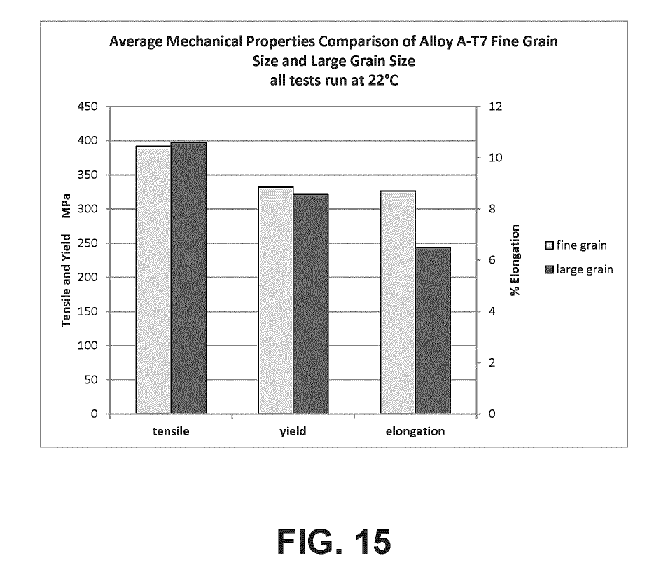

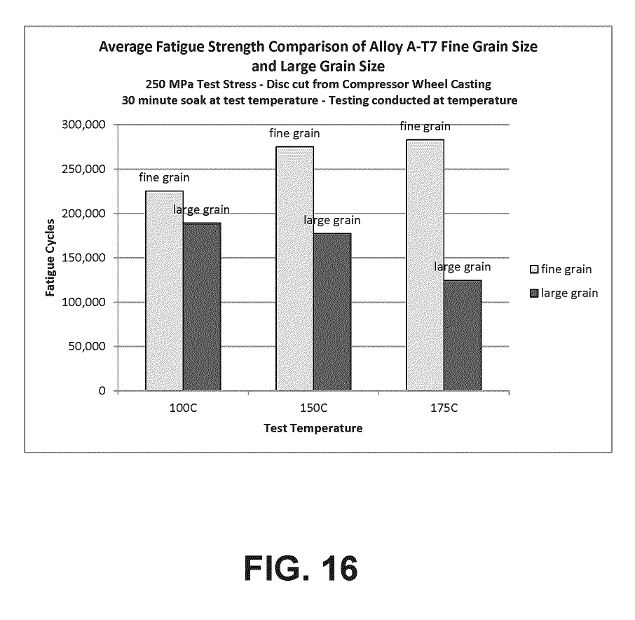

Mechanical property comparison testing was performed by comparing samples of Alloy A (Alloys A1 and A2 in Table 1) as described in Example 1 with a similar alloy (Alloy B in Table 1) that did not include boron from the addition of a Ti—B grain refiner alloy, in order to determine the effect of grain size on the high-temperature mechanical properties of the alloy. The alloys were cast into compressor wheel castings, which were then processed through hot isostatic pressing and heat treatment as described in Example 1 above. Samples were then cut from the castings, as also described in Example 1 above. Alloy A produced an average grain size of approximately 50 μm, while Alloy B produced an average grain size of approximately 1000 μm, as shown in FIG. 14. The samples were then soaked for 30 minutes at room temperature (22° C.), 100° C., 150° C., 175° C., and 200° C., and were then tested for ultimate tensile strength, yield strength, and fatigue strength using testing as described above in Example 1. Some results of this testing are summarized in FIGS. 15-16. As shown in FIG. 15, the tensile strength and yield strength for both samples were approximately the same, indicating that grain size has little effect on tensile strength. Some effect may be observed at high temperatures (e.g., 200° C.). However, as shown in FIG. 16, the high temperature fatigue strength was significantly better for the fine grain Alloy A than the coarse grain Alloy B. The samples were also examined metallographically, and fatigue fractures were found to occur along grain boundaries in the coarse grain Alloy B.

In summary, a fine grain size was demonstrated to have a significant effect on high temperature fatigue strength in alloys according to aspects of this disclosure. Without being bound by a particular theory, it is contemplated that the grain boundaries in the coarse-grained alloys facilitate propagation of fatigue fractures. It is also contemplated that this effect may be exacerbated in thin wall parts, particularly if the wall thickness is on the same order as the grain size, as smaller grains both disperse brittle phases (e.g. Cu phases) at grain boundaries to a greater degree and also provide a more complex and difficult path for crack propagation between grains.

### EXAMPLE 4

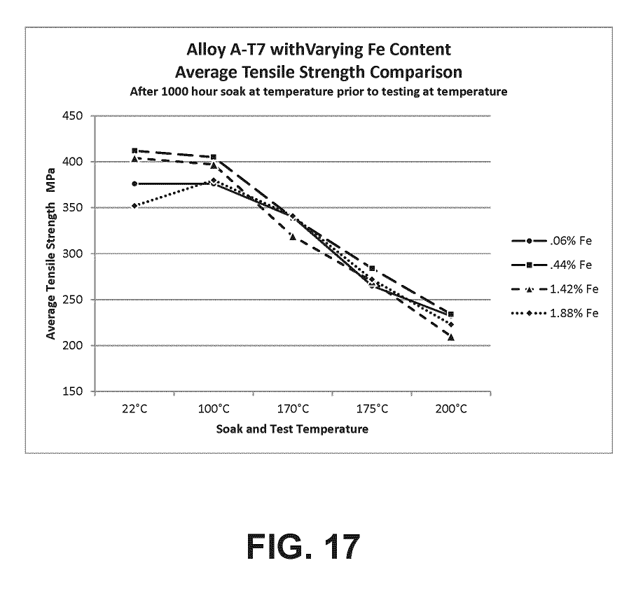

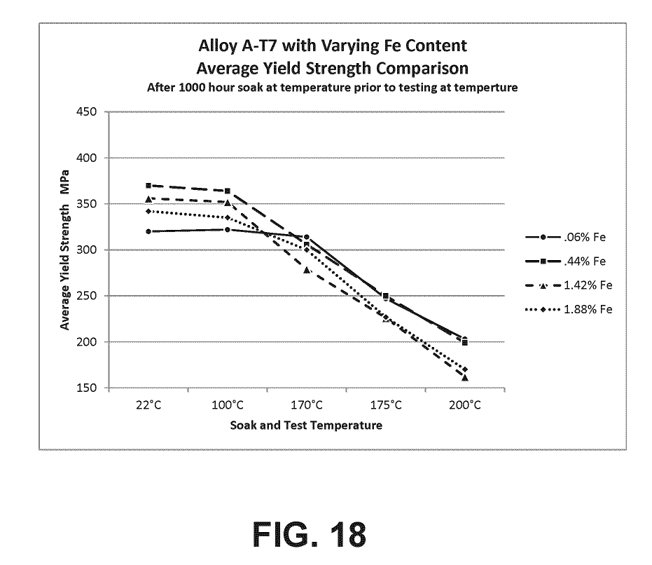

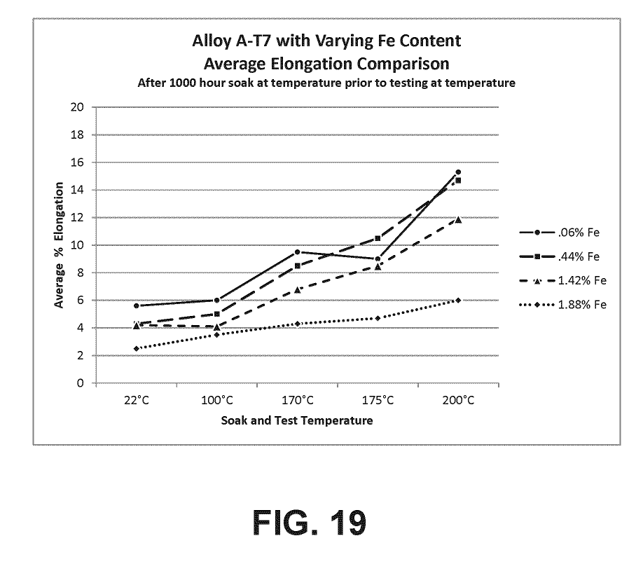

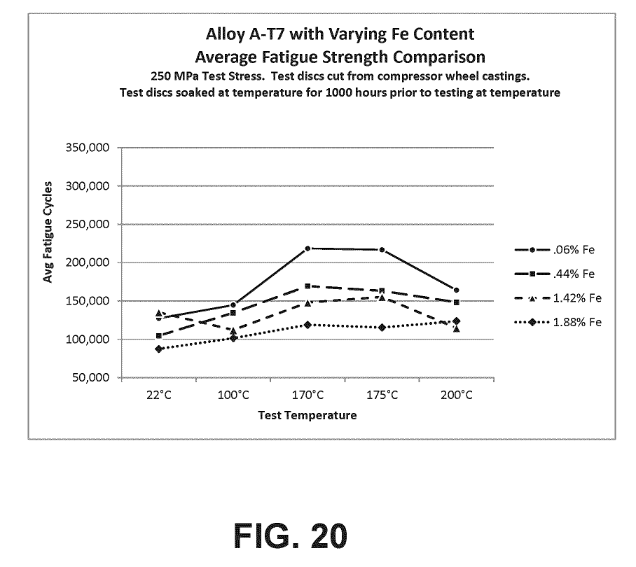

To test the effect of iron content on the mechanical properties of Alloy A, samples of Alloy A6 in Table 1 were prepared as described above, having iron contents of 0.06 wt. %, 0.44 wt. %, 1.42 wt. %, and 1.88 wt. %. The mechanical properties (tensile strength, yield strength, elongation, and fatigue performance) of these samples were tested as described above. The results of this testing are illustrated in FIGS. 17-20. FIGS. 17-18 illustrate marginally superior high-temperature tensile and yield strengths for the low-iron (0.06 wt. %) alloy. However, the low-iron alloy is shown to have superior high-temperature ductility and significantly superior high-temperature fatigue performance, as illustrated in FIGS. 19-20. This provides evidence to support the theory described in Example 1 above, i.e., that a mechanism leading to increased fatigue resistance in Alloy A is the reduction of brittle Fe-containing intermetallics in the alloy due to decreased iron content.

Samples were then cut from the castings of the A6 alloys described above having varying iron contents, and scanning electron micrographs of the samples were created. These micrographs are illustrated in FIG. 21 for all of the samples with different iron contents, and locations of Fe-containing intermetallics are identified with markings in the drawings. As can be seen in FIG. 21, the amount of Fe-containing intermetallics increases in the higher-Fe alloys. This also supports the theory that higher amounts of Fe-containing intermetallics result in inferior high-temperature fatigue resistance.

The embodiments described herein can provide advantages over existing alloys, castings, and processes, including advantages over existing casting and forging aluminum alloys for use in high temperature applications. For example, embodiments of the alloy described herein can provide comparable or superior high temperature mechanical properties, in comparison to forged alloys commonly used for high-temperature cyclic applications, such as 2618-T6, as well as superior corrosion resistance as compared to such forging alloys. This result is particularly surprising, as forged components are normally expected to outperform cast alloys in mechanical properties. The alloy described herein, as a casting alloy, also can be used to produce cast products at significantly lower cost, relative to producing the same components via a forging technique. As another example, alloys described herein can provide vastly increased high temperature mechanical properties in comparison to typical casting alloys, such as 354.0-T6. As a further example, alloys described herein can provide at least superior corrosion resistance to casting alloys having higher Cu and Fe content, as well as increased high temperature mechanical properties relative to such alloys. Other benefits and advantages are recognizable to those skilled in the art.

While the invention has been described with respect to specific examples including presently preferred modes of carrying out the invention, those skilled in the art will appreciate that there are numerous variations and permutations of the above described systems and methods. Thus, the spirit and scope of the invention should be construed broadly as set forth in the appended claims. All compositions herein are expressed in weight percent, unless otherwise noted. It is understood that all ranges and nominal compositions described herein may include variations beyond the exact numerical values listed in certain embodiments, and that the term “about” may be utilized in the claims to signify such variation. It is also understood that compositions recited herein may comprise, consist of, or consist essentially of, the combinations of alloying elements discussed herein.

1. An aluminum alloy comprising, in weight percent:
Si: 0.1-0.25
Fe: 0.10 max
Cu: 2.0-3.4
Ni: 0.9-1.2
Mg: 1.3-1.8
Ti: 0.25 max, and
one or more dispersoid forming elements, the balance being aluminum and unavoidable impurities.

2. The alloy of claim 1, wherein the one or more dispersoid forming elements are selected from the group consisting of: vanadium, zirconium, manganese, chromium, scandium, hafnium, niobium, yttrium, titanium, and combinations thereof.

3. The alloy of claim 2, wherein each of the one or more dispersoid forming elements are present in an amount of up to 0.20 wt. %.

4. The alloy of claim 2, wherein the one or more dispersoid forming elements are collectively present in an amount of up to 0.20 wt. %.

5. The alloy of claim 1, wherein the Fe content is 0.08 max wt. %.

6. The alloy of claim 1, wherein the Fe content is 0.06 max wt. %.

7. The alloy of claim 1, wherein the Cu content is 2.0-3.2 wt. %.

8. The alloy of claim 1, wherein the Cu content is 2.0-3.0 wt. %.

9. The alloy of claim 1, wherein the Ti content is 0.20 max wt. %.

10. The alloy of claim 1, wherein the alloy further includes 0.1 max wt. % Zn as an impurity.

11. The alloy of claim 1, wherein the unavoidable impurities may each be present at a maximum weight percent of 0.05, and the maximum total weight percent of the unavoidable impurities is 0.15.

12. The alloy of claim 1, wherein the alloy is cast, and wherein an average grain size of the alloy is 100 μm or less.

13. (canceled)

14. A cast aluminum alloy product formed of an aluminum alloy according to claim 1.

15. The cast aluminum alloy product of claim 14, wherein the cast aluminum alloy product is a turbocharger impeller.

16. The cast aluminum alloy product of claim 14, wherein the product can withstand at least 150,000 cycles at a load of 250 MPa after soaking at least 1000 hours at a temperature of 200° C.

17.-18. (canceled)

19. The cast aluminum alloy product of claim 14, wherein the product has a B1 reliability value of at least 60,000 cycles at a load of 250 MPa after soaking at least 1000 hours at a temperature of 200° C.

20.-21. (canceled)

22. A method of forming a cast product, comprising:
casting an aluminum alloy to form the cast product, the alloy comprising:
Si: 0.1-0.25
Fe: 0.10 max
Cu: 2.0-3.4
Ni: 0.9-1.2
Mg: 1.3-1.8
Ti: 0.25 max, and
one or more dispersoid forming elements, the balance being aluminum and unavoidable impurities;
subjecting the cast product to hot isostatic pressing;
solution heat treating the cast product; and
artificially aging the cast product.

23. The method of claim 22, wherein the cast product is a turbocharger impeller.

24. The method of claim 22, wherein the cast product can withstand at least 150,000 cycles at a load of 250 MPa after soaking at least 1000 hours at a temperature of 200° C.

25.-26. (canceled)

27. The method of claim 22, wherein the solution heat treating and the artificially aging are accomplished using a T7 heat treatment.
